(19) United States
(12) Patent Application Publication
(10) Pub. No.: US 2011/0252316 A1
(43) Pub. Date: Oct. 13, 2011

(54) TRANSLATING TEXT ON A SURFACE COMPUTING DEVICE

(75) Inventors: Michel Pahud, Kirkland, WA (US); Takako Aikawa, Seattle, WA (US); Andrew D. Wilson, Seattle, WA (US); Hrvoje Benko, Seattle, WA (US); Sauleh Eetemadi, Bellevue, WA (US); Anand M. Chakravarty, Sammamish, WA (US)

(73) Assignee: Microsoft Corporation, Redmond, WA (US)

(21) Appl. No.: 12/758,060

(22) Filed: Apr. 12, 2010

(51) Int. Cl. G06F 17/28; G06F 3/01; G06F 17/24; G06F 3/048

(52) U.S. Cl. 715/264; 715/753; 704/3; 715/823

(57) ABSTRACT

A system described herein includes an acquirer component that acquires an electronic document that comprises text in a first language, wherein the acquirer component acquires the electronic document based at least in part upon a physical object comprising the text contacting or becoming proximate to the interactive display of the surface computing device. The system also includes a language selector component that receives an indication of a second language from a user of the surface computing device and selects the second language. A translator component translates the text in the electronic document from the first language to the second language, and a formatter component formats the electronic document for display to the user on the interactive display of the surface computing device, wherein the electronic document comprises the text in the second language.

### BACKGROUND

Technology pertaining to interactive displays has advanced in recent years such that interactive displays can be found in many consumer-level devices and applications. For example, banking machines often include interactive displays that allow users to select a function and an amount for withdrawal or deposit. In another example, mobile computing devices such as smart phones may include interactive displays, wherein such displays can be employed in connection with user selection of graphical icons through utilization of a stylus or finger. In still yet another example, some laptop computers are equipped with interactive displays that allow users to generate signatures, select applications and perform other tasks through utilization of a stylus.

The popularity of interactive displays has increased due at least in part to ease of use, particularly for novice computer users. For example, novice computer users may find it more intuitive to select a graphical icon by hand than to select the icon through use of various menus and pointing and clicking mechanisms, such as a mouse. In currently available interactive displays, a user can select, move, modify or perform other tasks on objects that are visible on a display screen by touching such objects with a stylus, a finger or the like.

Interactive displays can also be found in devices that can be used collaboratively by multiple users, wherein such devices can be referred to as surface computing devices. A surface computing device may comprise an interactive display, wherein multiple users can collaborate on a project by interacting with one another on the surface computing device by way of the interactive display. For example, a first user may generate an electronic document and share such document with a second individual by selecting the document with a hand on the interactive display and moving the hand in a direction toward the second individual. Collaboration can be difficult, however, when individuals wishing to collaborate understand different languages.

### SUMMARY

The following is a brief summary of subject matter that is described in greater detail herein. This summary is not intended to be limiting as to the scope of the claims.

Various technologies pertaining to translating text in an electronic document from a first language to a second language on a surface computing device are described herein. A surface computing device can be a device that comprises an interactive display that can capture electronic documents by way of such interactive display. Furthermore, a surface computing device can be a collaborative computing device such that multiple users can collaborate on a task utilizing the surface computing device. Furthermore, the surface computing device can have a multi-touch interactive display such that multiple users can interact with the display at a single point in time. In some examples, a surface computing device can comprise a display that acts as a “wall” display, can comprise a display that acts as a tabletop (e.g., as a conference table), etc.

As mentioned, the surface computing device can comprise an interactive display that can be utilized to capture electronic documents. For example, the surface computing device can capture an image of a document that is placed on the interactive display, wherein the document can comprise at least some text in a first language. In another example, the surface computing device can be configured to download electronic documents retained in a portable computing device, such as a smart phone, when the portable computing device is placed upon or positioned proximate to the interactive display. For instance, a user can place a smart phone on top of the interactive display, which can cause the surface computing device to communicate with the smart phone by way of a suitable communication protocol. The surface computing device can obtain a list of electronic documents included in the portable computing device and an owner of the portable computing device can select documents which are desirably downloaded to the surface computing device. Of course, the surface computing device can obtain electronic documents in other manners such as by way of a network connection, through transfer from a disk or flash memory drive, by a user creating an electronic document anew on the surface computing device, etc.

Prior to or subsequent to the surface computing device obtaining the electronic document that comprises the text in the first language, the surface computing device can receive an indication from a user of a target language, wherein the user wishes to view text in the target language. In an example, this indication can be obtained by the surface computing device when an object corresponding to the user, such as an inanimate object, is placed upon or proximate to the interactive display of the surface computing device. For instance, the user can place a smart phone on the interactive display and the surface computing device can ascertain a language that corresponds to such user based at least in part upon data transmitted from the smart phone to the surface computing device. In another example, the user may have a business card that comprises a tag, which can be an electronic tag (such as an RFID tag) or an image-based tag (such as a domino tag). When the user places the business card on the interactive display, the surface computing device can analyze the tag to determine a preferred language of the user. Furthermore, the surface computing device can ascertain location of the tag, and utilize such location in connection with determining location of the user (e.g., in connection with displaying documents in the preferred language to the user). In yet another example, the user can select a preferred language by choosing the language from a menu presented to the user on the interactive display. Still further, the user can inform the surface computing device of the preferred language by voice command.

The surface computing device may thereafter be configured to translate the text in the captured electronic document from the first language to the target language. The surface computing device may be further configured to present the text in the target language in a format suitable for display to the user. Translating text between languages on the surface computing device enables many different scenarios. For instance, an individual may be traveling in a foreign country and may obtain a pamphlet that is written in a language that is not understood by the individual. The individual may obtain the pamphlet and utilize the surface computing device to generate an electronic version of a page of such pamphlet. Text in the pamphlet can be automatically recognized by way of any suitable object character recognition system and such text can be translated to a language that is understood by the individual. In another example, two individuals that wish to collaborate on a project may utilize the surface computing device. The surface computing device can capture an electronic document of the first individual, can translate text in the electronic document to a language understood by the second individual, and present translated text to the second individual. The first and second individuals may thus simultaneously review the document on the surface computing device in languages that are understood by such respective individuals.

Other aspects will be appreciated upon reading and understanding the attached figures and description.

### BRIEF DESCRIPTION OF THE DRAWINGS

FIG. 1 is a functional block diagram of an example system that facilitates translating text from a first language to a second language on a surface computing device.

FIG. 2 is an illustration of an example system component that is configured to acquire an electronic document that comprises text in a first language.

FIG. 3 is an illustration of an example system component that facilitates selecting a target language.

FIG. 4 is an illustration of an example system component that facilitates formatting translated text for display on a surface computing device.

FIG. 5 illustrates an example highlighting of corresponding text written in different languages on a surface computing device.

FIG. 6 illustrates an example translation of text from a first language to a second language when an electronic document is moved or copied to a particular portion of an interactive display on a surface computing device.

FIG. 7 is an example depiction of extracting text from an image and translating such text to a target language.

FIG. 8 illustrates translating text in an electronic document in a particular region of an interactive display of a surface computing device.

FIG. 9 illustrates translating a portion of a map selected by a user on a surface computing device.

FIG. 10 illustrates collaboration between multiple users that understand different languages utilizing different computing devices.

FIG. 11 is a flow diagram that illustrates an example methodology for acquiring an electronic document and translating text therein to a target language on a surface computing device.

FIG. 12 is a flow diagram that illustrates an example methodology for detecting a target language to utilize when translating text in electronic documents for an individual.

FIG. 13 is a flow diagram that illustrates an example methodology for translating text in an electronic document from a first language to a target language on a collaborative surface computing device.

FIG. 14 is an example computing system.

### DETAILED DESCRIPTION

Various technologies pertaining to translating text from a first language to a second language on a surface computing device will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

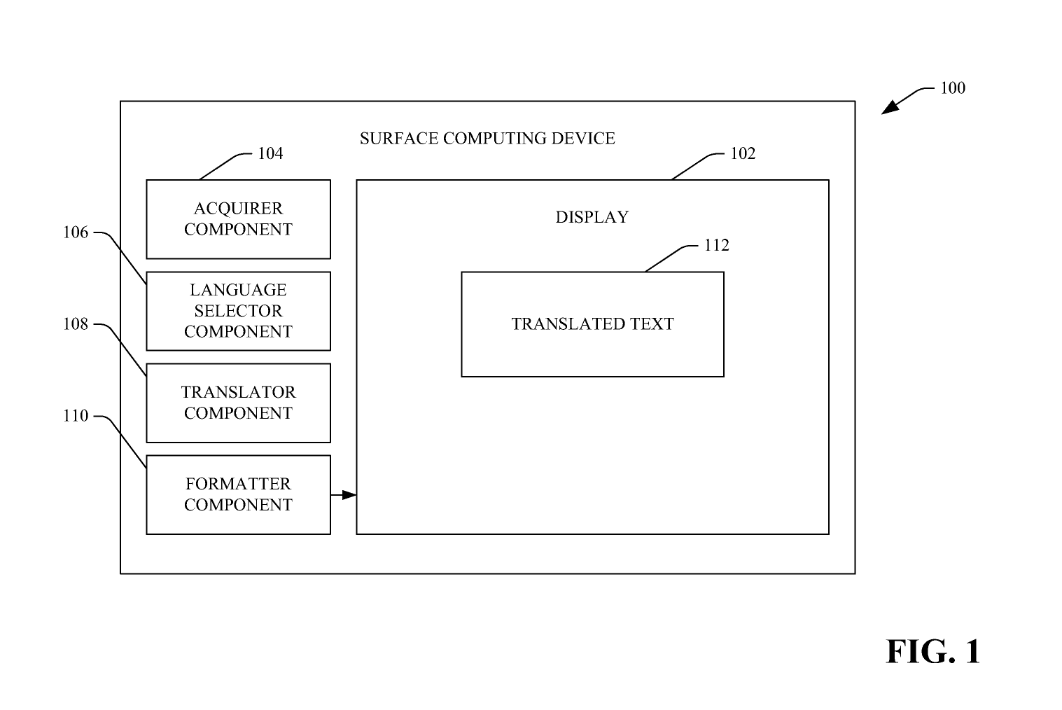

With reference to FIG. 1, an example surface computing device 100 that can be configured to translate text from a first language to a second language is illustrated. As used herein, a surface computing device can be a computing device with an interactive display, wherein electronic documents can be acquired by way of the interactive display. In another example, a surface computing device can be a computing device with a multi-touch display surface such that a user or a plurality of users can provide input by way of multiple touch points on the display of the surface computing device. In yet another example, a surface computing device can be a computing device that facilitates collaborative computing, wherein input can be received from different users utilizing the surface computing device simultaneously. In still yet another example, a surface computing device can have all of the characteristics mentioned above. That is, the surface computing device can have a multi-touch interactive display that can be configured to capture electronic documents by way of such display and the surface computing device can facilitate collaboration between individuals using such device.

As will be described herein, the surface computing device 100 can be configured to acquire an electronic document that comprises text written in a first language and can be configured to translate such text to a second language, wherein the second language is a language desired by a user. The surface computing device 100 can comprise a display 102 which can be an interactive display. In an example, the interactive display 102 may be a touch-sensitive display, wherein a user can interact with the surface computing device 100 by touching the interactive display 102 (e.g., with a finger, a palm, a pen, or other suitable physical object). The interactive display 102 can be configured to display one or more graphical objects to one or more users of the surface computing device 100.

The surface computing device 100 can also comprise an acquirer component 104 that can be configured to acquire one or more electronic documents. Pursuant to an example, the acquirer component 104 can be configured to acquire electronic documents by way of the interactive display 102. For instance, the acquirer component 104 can include or be in communication with a camera that can be positioned such that the camera captures images of documents residing upon the interactive display 102. The camera can be positioned beneath the display, above the display, or integrated inside the display. Thus, the acquirer component 104 can cause the camera to capture an image of the physical document placed on the interactive display 102.

In another example, the acquirer component 104 can include or be in communication with a wireless transmitter located in the surface computing device 100, such that if a portable computing device capable of transmitting data by way of a wireless protocol (such as Bluetooth) is placed on or proximate to the interactive display 102, the surface computing device 100 can retrieve electronic documents stored on such portable computing device. That is, the acquirer component 104 can be configured to cause the surface computing device 100 to acquire one or more electronic documents that are stored on the portable computing device, which can be a mobile telephone.

In yet another example, an individual may generate a new/original electronic document through utilization of the interactive display 102. For instance, the user can utilize a stylus or finger to write text in a word processing program, and the acquirer component 104 can be configured to facilitate acquiring an electronic document that includes such text.

Other manners for acquiring electronic documents that do not involve interaction with the interactive display 102 are contemplated. For example, the acquirer component 104 can acquire an electronic document from a data store that is in communication with the surface computing device 100 by way of a network connection. Thus, the acquirer component 104 can acquire a document that is accessible by way of the Internet, for instance. In another example, an individual may provide a disk or flash drive to the surface computing device 100, and the acquirer component 104 can acquire one or more documents which are stored on such disk/flash drive.

The surface computing device 100 can also comprise a language selector component 106 that selects a target language, wherein the target language is desired by an individual wishing to review the captured electronic document. For instance, the target language may be a language that is understood by the individual wishing to review the captured electronic document. In another example, the individual may not fluently speak the target language, but may wish to be provided with documents written in the target language in an attempt to learn the target language. In an example, the language selector component 106 can receive an indication of a language that the individual understands by way of the individual interacting with the interactive display 102. For example, the individual can place a mobile computing device on the interactive display 102 (or proximate to the interactive display), and the mobile computing device can output data that is indicative of the target language preferred by the user by way of a suitable communications protocol (e.g., a wireless communications protocol). The surface computing device 100 can receive the data output by the mobile computing device, and the language selector component 106 can select such language (e.g., directly or indirectly). For instance, the language selector component 106 can select the language by way of a web service.

In another example, the individual may place a physical object that has a tag corresponding thereto on or proximate to the interactive display 102. Such tag may be a domino tag which comprises certain shapes that are recognizable by the surface computing device 100. Also, the tag may be a RFID tags that is configured to emit RFID signals that can be received by the surface computing device 100. Other tags are also contemplated by the inventors and are intended to fall under the scope of the hereto-appended claims. Thus, by interacting with the interactive display 102 through utilization of an object, an individual can indicate a preferred target language.

In another embodiment, the individual may indicate to the language selector component 106 a preferred language without interacting with the interactive display 102 through utilization of an object. For instance, the language selector component 106 can be configured to display a graphical user interface to the individual, wherein the graphical user interface comprises a menu such that the individual can select the target language from a list of languages. In another example, the individual may output voice commands to indicate the preferred language and the language selector component 106 can select a language based at least in part upon the voice commands. In still yet another example, the language selector component 106 can “listen” to the individual to ascertain an accent or to otherwise learn the language spoken by the individual and can select the target language based at least in part upon such spoken language.

The surface computing device 100 can further comprise a translator component 108 that is configured to translate text in the electronic document acquired by the acquirer component 104 from the first language to the target language that is selected by the language selector component 106. A formatter component 110 can then format the text in the target language for display to the individual on the interactive display 102. Specifically, the formatter component 110 can cause translated text 112 to be displayed on the interactive display 102 of the surface computing device 100.

The translation of text from a first language to a target language on the surface computing device 100 provides for a variety of scenarios. For example, a first individual may be traveling in a foreign country where such individual does not speak the native language of such country. The individual may obtain a newspaper, pamphlet or other piece of written material and be unable to understand the contents thereof. The individual can utilize the surface computing device 100 to obtain an electronic version of such document by causing the acquirer component 104 to acquire a scan/image of the document. Text extraction/optical character recognition (OCR) techniques can be utilized to extract the text from the electronic document, and the language selector component 106 can receive an indication of the preferred language of the individual. The translator component 108 may then translate the text from the language not understood by the individual to the preferred language of the individual. The formatter component 110 may then format the text for display to the individual on the interactive display 102 of the surface computing device 100.

Furthermore, as mentioned above, the surface computing device 100 can be a collaborative computing device. For instance, a first individual and a second individual can collaborate on the surface computing device 100, wherein the first individual understands a first language and the second individual understands a second language. The first individual may wish to share a document with the second individual, and the acquirer component 104 can acquire an electronic version of such document from the first individual, wherein text of the electronic document is in the first language. The language selector component 106 can ascertain that the second individual wishes to review text written in the second language, and the language selector component 106 can select such second language. The translator component 108 can translate text in the electronic document from the first language to the second language and the formatter component 110 can format the translated text for display to the second individual. These and other scenarios will be described below in greater detail.

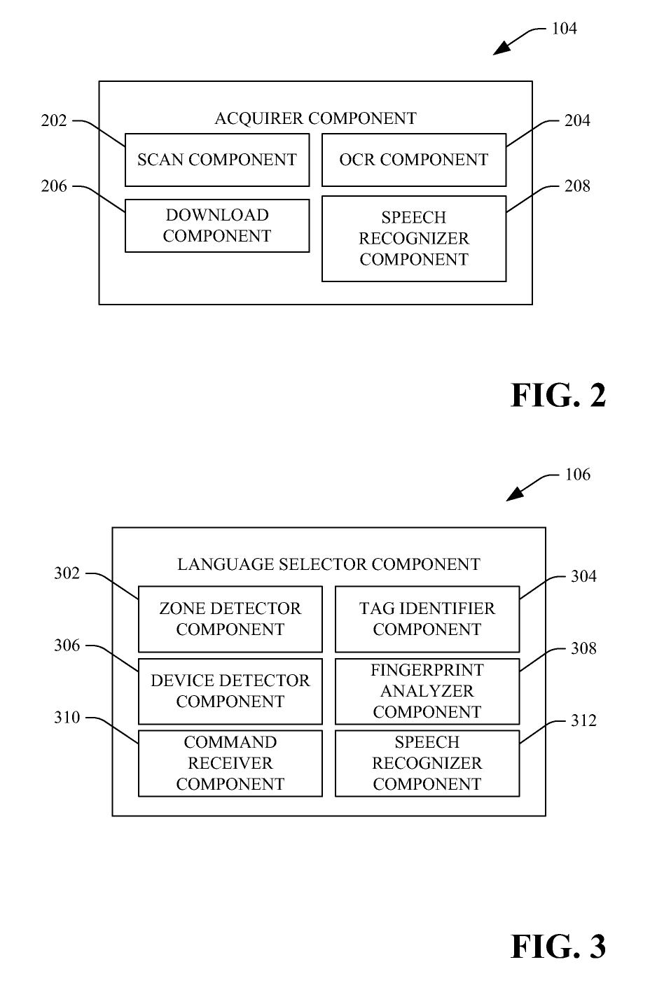

Referring now to FIG. 2, an example depiction of the acquirer component 104 is illustrated. As described above, the acquirer component 104 is configured to acquire electronic documents from an individual, wherein such documents include text that is desirably translated from a first language to a second language. In an example embodiment, the acquirer component 104 can acquire electronic documents by way of the interactive display 102 of the surface computing device 100, wherein the acquirer component 104 acquires electronic documents based at least in part upon a physical object that includes text desirably translated contacting or becoming proximate to the interactive display 102 of the surface computing device 100.

In an example, the acquirer component 104 can comprise a scan component 202 that is configured to capture an image of (e.g., scan) a physical document that is placed on the display of the surface computing device 100. For instance, the scan component 202 can comprise or be in communication with a camera that is configured to capture an image of the electronic document when it is contacting or sufficiently proximate to the interactive display 102 of the surface computing device 100. The camera can be positioned behind the interactive display 102 such that the camera can capture an image of the document laying on the interactive display 102 through the interactive display 102. In another example, the camera can be positioned facing the interactive display 102 such that the individual can place the electronic document “face up” on the interactive display 102.

The interactive display 102 can sense that a physical document is lying thereon, which can cause the scan component 202 to capture an image of such electronic document. The acquirer component 104 can also include an object character recognition (OCR) component 204 that is configured to extract text from the electronic document captured by the scan component 202. Thus, the OCR component 204 can extract text written in the first language from the electronic document captured by the acquirer component 104. The OCR component 204 can be configured to extract printed text and/or handwritten text. Text extracted by the OCR component 204 can then be translated to a different language.

Additionally or alternatively, the acquirer component 104 can comprise a download component 206 that is configured to download electronic documents that are stored in a portable computing device to the surface computing device 100. The portable computing device may be, for example, a smart phone, a portable media player, a net book or other suitable portable computing device. In an example, the acquirer component 104 can sense by way of electronic signals, pressure sensing, and/or image-based detection when the portable computing device is in contact with or proximate to the interactive display 102 of the surface computing device 100. In an example, “proximate to” can mean that the portable computing device is within one inch of the interactive display 102 of the surface computing device 100, within three inches of the interactive display 102 of the surface computing device 100, or within six inches of the interactive display 102 of the surface computing device 100. For example, the acquirer component 104 can be configured to transmit and receive Bluetooth signals or other suitable signals that can be output by a portable computing device and can be further configured to communicate with the portable computing device by Bluetooth signals or other wireless signals.

Once the portable computing device and the acquirer component 104 have established a communications channel, the acquirer component 104 can transmit signals to the portable computing device to cause at least one electronic document stored in the computing device to be transferred to the surface computing device 100. For instance, the acquirer component 104 can cause a graphical user interface to be displayed on the interactive display 102 of the surface computing device 100, wherein the graphical user interface lists one or more electronic documents that are stored on the portable computing device that can be transferred from the portable computing device to the surface computing device 100. The owner/operator of the portable computing device may then select which electronic documents are desirably transferred to the surface computing device 100 from the portable computing device. The electronic documents downloaded to the surface computing device 100 can be any suitable format, such as a word processing format, an image format, etc. If the electronic document is in an image format, the OCR component 204 can be configured to extract text therefrom as described above. Alternatively, the text may be machine readable such as in a word processing document. Once the download component 206 has been utilized to acquire an electronic document from the portable computing device, text in the electronic document can be translated from a first language to a second language.

In another example, the acquirer component 204 can be configured to generate an electronic document from spoken words of the individual. That is, the acquirer component 104 can include a speech recognizer component 208 that can be configured to recognize speech of an individual in a first language and generate an electronic document that includes text corresponding to such speech. For instance, the speech recognizer component 208 can convert speech to text and display such text on the interactive display 102 of the surface computing device 100. The individual may modify such text if there are any mistaken translations from speech to text and thereafter such text can be translated to a second language.

In still yet another embodiment, the acquirer component 104 can be configured to acquire an electronic document that is generated by an individual through utilization of the surface computing device 100. For example, the surface computing device 100 may have a keyboard attached thereto and the individual can utilize a word processing application and the keyboard to generate an electronic document. Text in the electronic document may be in a language understood by the individual and such text can be translated to a second language that can be understood by an individual with whom the first individual is collaborating on the surface computing device 100 or another computing device.

Now referring to FIG. 3, an example detailed depiction of the language selector component 106 is illustrated. The language selector component 106 can be configured to select a language to which text and electronic documents are desirably translated with respect to a particular individual. As will be described in greater detail below, the language selector component 106 can select different languages for different zones of the interactive display 102 of the surface computing device 100. For instance, in a collaborative setting a first individual using a first zone of the interactive display 102 may wish to review text in a first language while a second individual utilizing a second zone of the interactive display 102 may wish to view text in a second language. Furthermore, the language selector component 106 can be configured to receive an indication of a language by way of an object being placed on the interactive display 102 or being placed proximate to the interactive display 102. Moreover, in an example, the translated document can be displayed based at least in part upon location of the object on the interactive display.

The language selector component 106 can comprise a zone detector component 302 that is configured to identify a zone corresponding to an individual utilizing the interactive display 102 of the surface computing device 100. For example, if a single user is utilizing the surface computing device 100, the zone detector component 302 can identify that the entirety of the interactive display 102 is the zone. In another example, if multiple individuals are utilizing the surface computing device 100 then the zone detector component 302 can subdivide/divide the interactive display 102 into a plurality of zones, wherein each zone corresponds to a different respective individual using the interactive display 102 of the surface computing device 100. For instance, the zones can dynamically move as users move their physical objects, and size of the zones can be controlled based at least in part upon user gestures (e.g., a pinching gesture). In still yet another example, the zone detector component 302 can detect that an individual is interacting with a particular position on the interactive display 102 and can detect a zone that is a radius around such point of action.

The language selector component 106 may also comprise a tag identifier component 304 that can identify a tag corresponding to an individual, wherein the tag can be indicative of a target language preferred by the individual. A tag identified by the tag identifier component 304 can be some form of visual tag such as a domino tag. A domino tag is a tag that comprises a plurality of shaded or colored geometric entities (such as circles), wherein the shape, color, and/or orientation of the geometric entities with respect to one another can be utilized to determine a preferred language (target language) of the individual. As described above, the surface computing device 100 can include a camera, and the tag identifier component 304 can review images captured by the camera to identify a tag. The tag can correspond to a particular person or language and the language selector component 106 can select a language for the individual that placed the tag on the interactive display 102 of the surface computing device 100.

The language selector component 106 can further include a device detector component 306 that can detect that a portable computing device is in contact with the interactive display 102 or proximate to the interactive display 102. For example, the device detector component 306 can be configured to communicate with a portable computing device by way of any suitable wireless communications protocol such as Bluetooth. The device detector component 306 can detect that the portable computing device is in contact with or proximate to the interactive display 102 and can identify a language preferred by the owner/operator of the portable computing device. The language selector component 106 can then select the language to translate text based at least in part upon the device detected by the device detector component 306.

In still yet another example, the language selector component 106 can select a language corresponding to an individual to which to translate text based at least in part upon a fingerprint of the individual. That is, the language selector component 106 can comprise a fingerprint analyzer component 308 that can receive a fingerprint of an individual and can identify the individual and/or a language preferred by such individual based at least in part upon the fingerprint. For instance, a camera or other scanning device in the surface computing device 100 can capture a fingerprint of the individual and the fingerprint analyzer component 308 can compare the fingerprint with a database of known fingerprints. The database may have an indication of language preferred by the individual corresponding to the fingerprint and the language selector component 106 can select such language for the individual. The database can be included in the surface computing device 100 or located on a remote server. Thereafter, text desirably viewed by the individual can be translated to the language preferred by such individual.

Furthermore, an individual can select a preferred language from a menu and the language selector component 106 and select the language based at least in part upon the language chosen by the individual. A command receiver component 310 can cause a graphical user interface to be displayed, wherein the graphical user interface includes a menu of languages that can be selected, and wherein text will be translated to a selected language. The individual may then traverse the items in the menu to select a desired language. The command receiver component 310 can receive such selection and the language selector component 106 can select the language chosen by the individual. Thereafter, text desirably viewed by the individual will be translated to the selected language.

The language selector component 106 can also comprise a speech recognizer component 312 that can recognize speech of an individual, wherein the language selector component 106 can select the language spoken by the individual. If an individual is utilizing the surface computing device 100 and issues a spoken command to translate text into a particular language, for instance, the speech recognizer component 312 can recognize such command and the language selector component 106 can select the language chosen by the individual. In another example, the speech recognizer component 312 can listen to speech and automatically determine the language spoken by the individual, and the language selector component 106 can select such language as the target language.

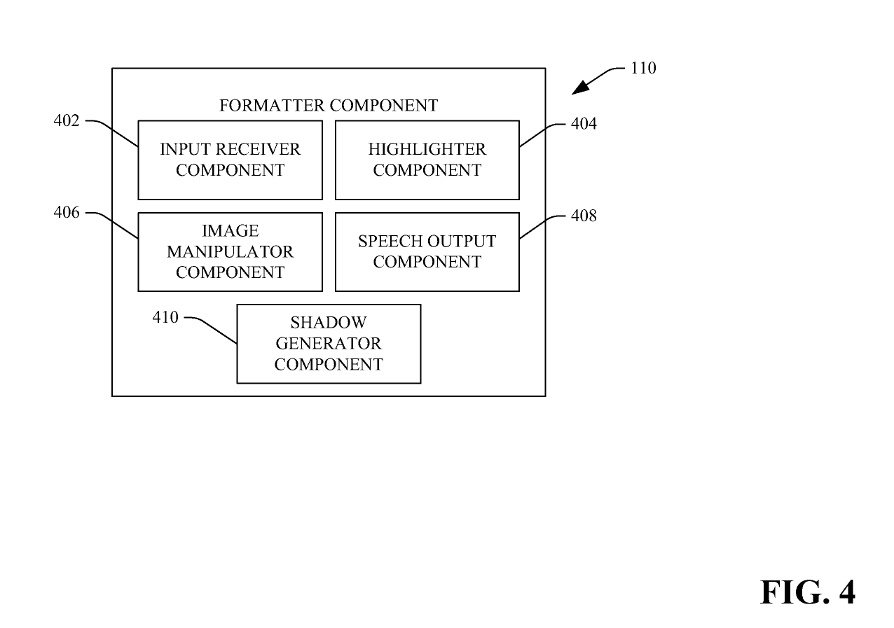

With reference now to FIG. 4, an example depiction of the formatter component 110 is illustrated. The formatter component 110 can be configured to format text in a manner that is suitable for display to one or more individuals utilizing the surface computing device 100 or individuals collaborating across connected surface computing devices. The formatter component 110 can include an input receiver component 402 that receives input from at least one individual pertaining to how the individual wishes to have text formatted for display on the interactive display 102 of the surface computing device 100. In another example, the formatter component 110 can cause the output format to be substantially similar to the input format. For instance, the input receiver component 402 can receive touch input from at least one individual, wherein the touch input is configured to identify to the formatter component 110 how the individual wishes to have text formatted on the interactive display 102 of the computing device 100. In an example embodiment, the first individual and a second individual may be collaborating on the surface computing device 100, wherein the first individual understands a first language and the second individual understands a second language. The first individual may be viewing a first instance of an electronic document that includes text in the first language and the second individual may be viewing a second instance of the electronic document that is written in the second language. In an example, the input receiver component 402 can receive an indication of a selection of a portion of text in the first instance of the first document from the first individual. A highlighter component 404 can cause a corresponding portion of text in the second instance of the electronic document to be highlighted such that the second individual can ascertain what is being discussed or desirably pointed out by the first individual. This can effectively reduce a language barrier existent between the first individual and the second individual. Of course, the second individual can also select a portion of text in the second instance of the electronic document, and the highlighter component 404 can cause a corresponding portion of the first instance of the electronic document to be highlighted.

The formatter component 110 can also include an image manipulator component 406 that can be utilized to selectively position an image in an electronic document after text corresponding to such image has been translated. For instance, an individual may be in a foreign country and may pick up a pamphlet, newspaper or other physical document, wherein such physical document comprises text and one or more images. The individual may utilize the surface computing device 100 to capture a scan of such document. Furthermore, a desired target language can be selected as described above. Text can be automatically extracted from the electronic document, and the text can be translated to the target language. The image manipulator component 406 can cause the one or more images in the electronic document to be positioned appropriately with reference to the translated text (or can cause the translated text to be positioned appropriately with reference to the image). In other words, the individual can be provided with the pamphlet as if the pamphlet were written in the target language desired by the individual.

The formatter component 110 can further include a speech output component 408 that is configured to perform text to speech, such that an individual can audibly hear how one or more words or phrases sound in a particular language. In an example, an individual may be in a foreign country at a restaurant, wherein the restaurant has menus that comprise text in a language that is not understood by the individual. The individual may utilize the surface computing device 100 to capture an image of the menu, and text in such menu can be translated to a target language that is understood by the individual. The individual may then be able to determine which item he or she wishes to order from the menu. The individual, however, may not be able to communicate such wishes in the language in which the menu is written. Accordingly, the speech output component 408 can receive a selection of the individual of a particular word or phrase and such word or phrase can be output in the original language of the document. Therefore, in this example, the individual can inform a waiter of a desired menu selection.

As mentioned previously, the surface computing device 100 can be collaborative in nature such that two or more people can simultaneously utilize the surface computing device 100 to perform a collaborative task. In another embodiment, however, multiple surface computing devices can be connected by way of a network connection and people in different locations can collaborate on a task utilizing different surface computing devices in various locations. The formatter component 110 can include a shadow generator component 410 that can capture a location of arms/hands of an individual utilizing a first surface computing device and cause a shadow to be generated on a display of a second surface computing device, such that a user of the second surface computing device can watch how the user of the first surface computing device interacts with such device. Further, the shadow generator component 410 can calibrate size of interactive displays on different surface computing devices such that a shadow of hands/arms shown on the surface computing device by the shadow generator component 410 appears to be natural on a surface computing device. That is, size of hands/arms shown on the surface computing device by the shadow generator component can correspond to the interactive display. In a particular example, a first user on a first surface computing device can select a portion of text in a first instance of an electronic document that is displayed as being in a first language. Meanwhile, a second instance of the electronic document is displayed on another computing device (possibly a surface computing device) to a second individual in a second language. The second individual can be shown location of arms/hands of the first individual on the second computing device, and such arms/hands can be dynamically positioned to show such hands selecting a corresponding portion of text in the second instance of the electronic document.

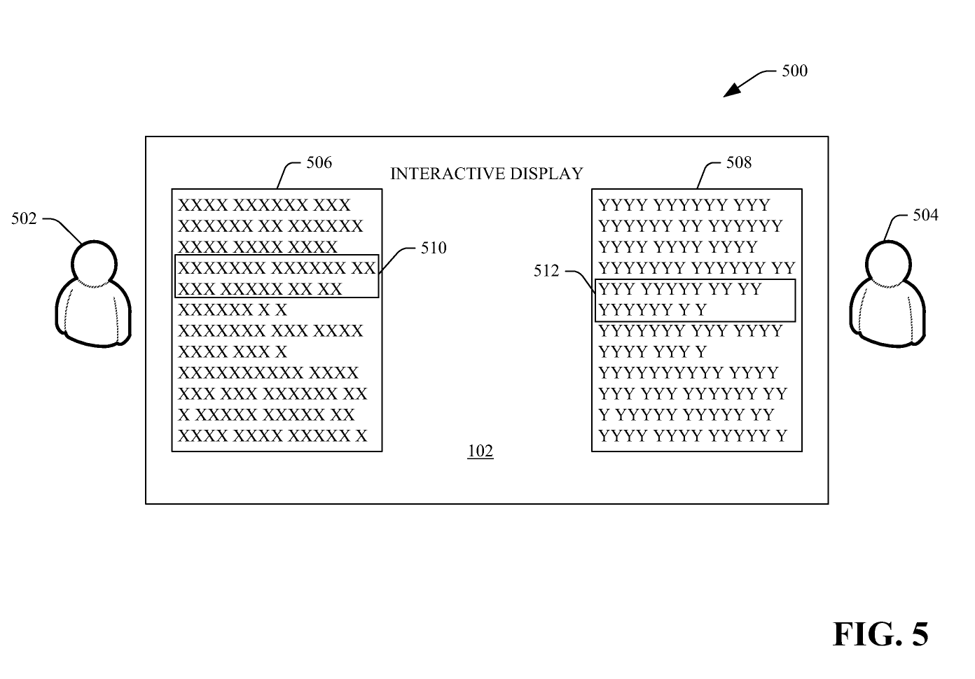

Referring collectively to FIGS. 5-9, various example scenarios that are enabled by combining the powers of surface computing with machine translations are depicted. Referring specifically to FIG. 5, an example scenario 500 where multiple users that speak different languages can collaborate on a surface computing device is illustrated. A first individual 502 and a second individual 504 desirably collaborate with one another on a display with respect to an electronic document. A first instance 506 of the electronic document is shown to the first individual 502 in a first zone of the interactive display 102. The first individual 502 may wish to share such electronic document with the second individual 504 but the individuals 502 and 504 speak different languages. The language preferred by the second individual 504 can be ascertained by way of any of the methods described above and a second instance 508 of the electronic document can be generated, wherein the second instance comprises the text of the electronic document in the second language. Accordingly the second individual 504 can read and understand content of the second instance 508 of the electronic document.

Additionally, the first individual 502 may wish to discuss a particular portion of the electronic document with the second individual 504. Again, however, the first individual 502 and the second individual 504 speak different languages. In this example, the first individual 502 can select a portion 510 of text in the first instance 506 of the electronic document. The first individual 502 can select such first portion 510 through utilization of a pointing and clicking mechanism, by touching a certain portion of the interactive display 102 with a finger, by hovering over a certain portion of the interactive display 102, or through any other suitable method. Upon the first individual 502 selecting the portion 510, a corresponding portion 512 of the second instance 508 of the electronic document can be highlighted. Moreover, in an example embodiment, the portions of text in the first instance 506 and the second instance 508 of the electronic document can remain highlighted until one of the users deselects such portion. Therefore, the second individual 504 can understand what the first individual 502 is referring to in the electronic document.

In another example, the first individual 502 may wish to make changes to the electronic document. For example, a keyboard can be coupled to the surface computing device 100 and the first individual 502 may make changes to the electronic document through utilization of the keyboard. In another example, the first individual 502 may utilize a virtual keyboard, a finger, a stylus or other tool to make changes directly on the first instance 506 of the electronic document (e.g., may “mark up” the electronic document). As the first individual 502 makes the changes to the first instance 506 of the electronic document, a portion of the second instance 508 of the electronic document can be updated and highlighted such that the second individual 504 can quickly ascertain what changes are being made to the electronic document by the first individual 502. Accordingly, a language barrier existent between the first individual 502 and the second individual 504 is effectively reduced. Furthermore, while scenario 500 illustrates two users employing the surface computing device to interact with one another, or collaborate on a project, it is to be understood that any suitable number of individuals can collaborate on such and portions can be highlighted as described above with respect to each of the individuals. Moreover, the individuals 502 and 504 may be collaborating on a project on different interactive displays of different surface computing devices.

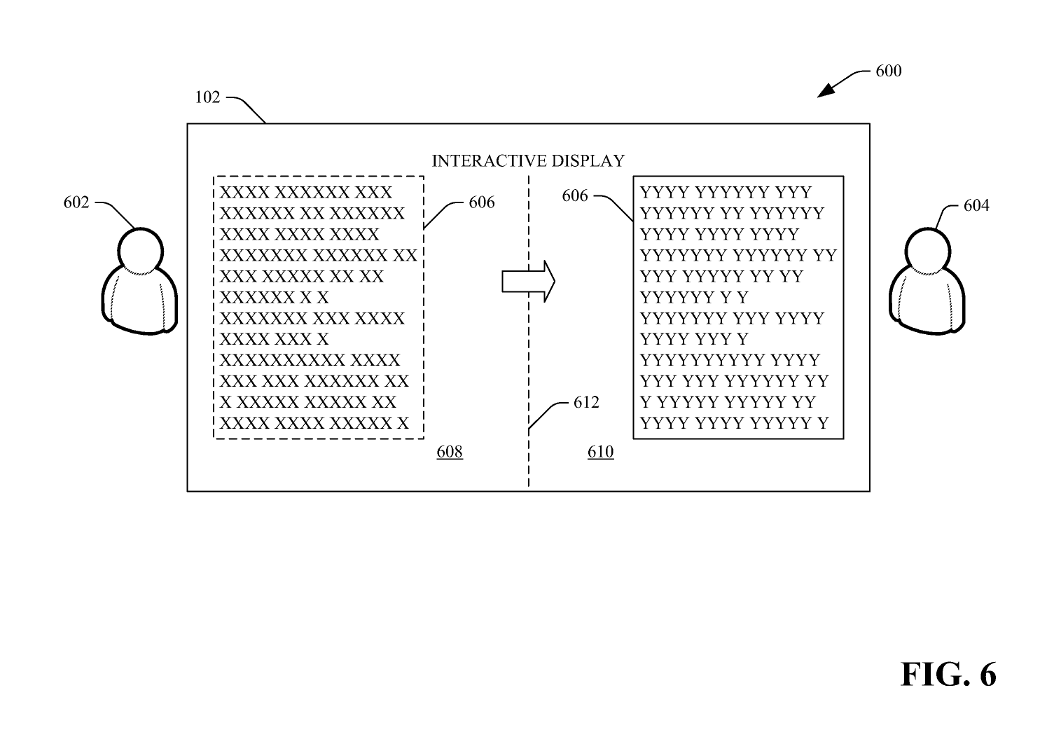

Referring now to FIG. 6, an example scenario 600 of two individuals collaborating with respect to an electronic document is illustrated. In this example, a first individual 602 and a second individual 604 are collaborating on a task on a surface computing device. The first individual 602 wishes to share an electronic document with the second individual 604 but the first and second individuals 602 and 604, respectively, communicate in different languages. The first individual 602 can provide or generate an electronic document 606, and such document 606 can be provided to the surface computing device. The electronic document 606 includes text in a first language that is understood by the first individual 602.

The first individual 602 wishes to share the electronic document with the second individual 604 and thus “passes” the electronic document 606 to the second user 604 across the interactive display 102. For instance, the first individual 602 can touch a portion of the interactive display 102 that corresponds to the electronic document 606 and can make a motion with their hand that causes the electronic document 606 to move toward the second individual 604. As the electronic document 606 moves across the interactive display 102, the electronic document can traverse from a first zone 608 corresponding to the first individual 602 to a second zone 610 corresponding to the second individual 604. As the electronic document 606 passes a boundary 612 between the first zone 608 and the second zone 610, the text in the electronic document 606 is translated to a language preferred by the second individual 604. The second individual 604 may then be able to read and understand contents of the electronic document 606, and can further make changes to such document 606 and “pass” it back to the first individual 602 over the interactive display 102. Again, while the scenario 600 illustrates two individuals utilizing the interactive display 102 of the surface computing device 100, it is to be understood that many more individuals can utilize the interactive display 102 and that some individuals may be in different locations on different surface computing devices networked together.

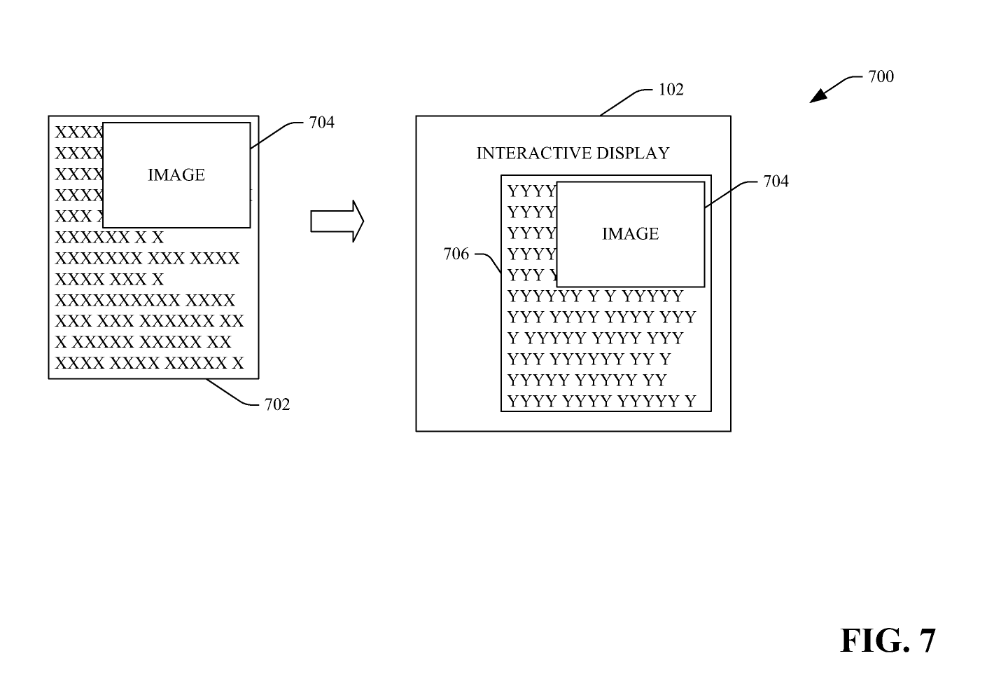

Referring now to FIG. 7, another example scenario 700 is enabled by combining powers of surface computing with machine translation. In this example scenario 700, an individual obtains a document 702 that comprises text written in a first language and an image 704. The individual can cause the surface computing device to capture an image of the document 702 by way of the interactive display, such that an electronic version of the document 702 exists on the surface computing device. The text can be translated from the original language in the document 702 to the language preferred by the individual. Furthermore, the translated text can be positioned with respect to the image 704 such that the electronic document 706 appears to the individual as if it were originally created in the second language on the interactive display 102.

Additionally, in another example embodiment, the image 704 itself may comprise text in the first language. This text in the first language can be recognized in the image 704 and erased therefrom, and attributes of such text, including size, font, color, etc. can be recognized. Replacement text in the second language may be generated, wherein such replacement text can have a size, font, color, etc. that corresponds to the text extracted from the image 704. This replacement text may then be placed in the image 704, such that the image appears to a user as if it originally included text in the second language.

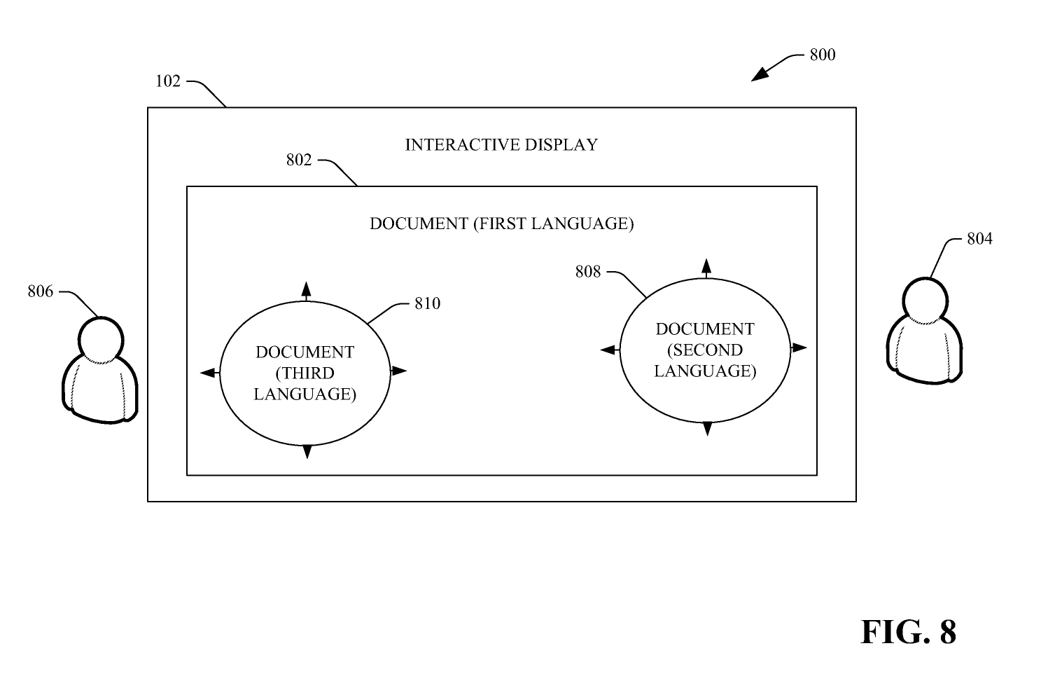

With reference now to FIG. 8, another example scenario 800 that can be enabled by combining the powers of surface computing with machine translation is illustrated. In this example, the interactive display 102 of the surface computing device displays a document 802 written in a first language to individuals 804 and 806. For instance, the surface computing device may be in a position where users that speak multiple languages can often be found, such as at an international airport. In an example, the document 802 may be a map such as a subway map, a roadmap, etc. that is desirably read by multiple users that speak multiple languages. The document 802, however, is written in a language corresponding to the location of the airport, and such language is not understood by either the first individual 804 or the second individual 806. However, these individuals 804-806 may wish to understand where it is that they are going on the maps. Accordingly, the first individual 804 can select a portion of the document 802 written in the first language with a finger, with a card that comprises a tag, with a portable computing device such as a smart phone, etc. This can inform the surface computing device 100 of a target language for the first individual 804. A zone 808 may be created in the document 802 such that text in the zone 808 is shown in the target language of the first individual 804. The first individual 804 may cause the zone 808 to move by transitioning a finger, the mobile computing device, the tag, etc. on the interactive display 102 to different locations. Thus, the zone 808 can move as the position of the individual 804 changes with respect to the interactive display 102.

Similarly, the second individual 806 may select a certain portion of the document 802 by placing a tag on the interactive display 102 somewhere in the document 802, by placing a mobile computing device such as a smart phone at a certain location in the document 802, or by pressing a finger at a certain location of the document 802, and a zone 810 around such selection can be generated (or multiple zones can be created for the second individual). Text in the zone 810 can be shown in a target language of the second individual 806 and location of such zone 810 can change as the position of the individual 806 changes with respect to the interactive display 102.

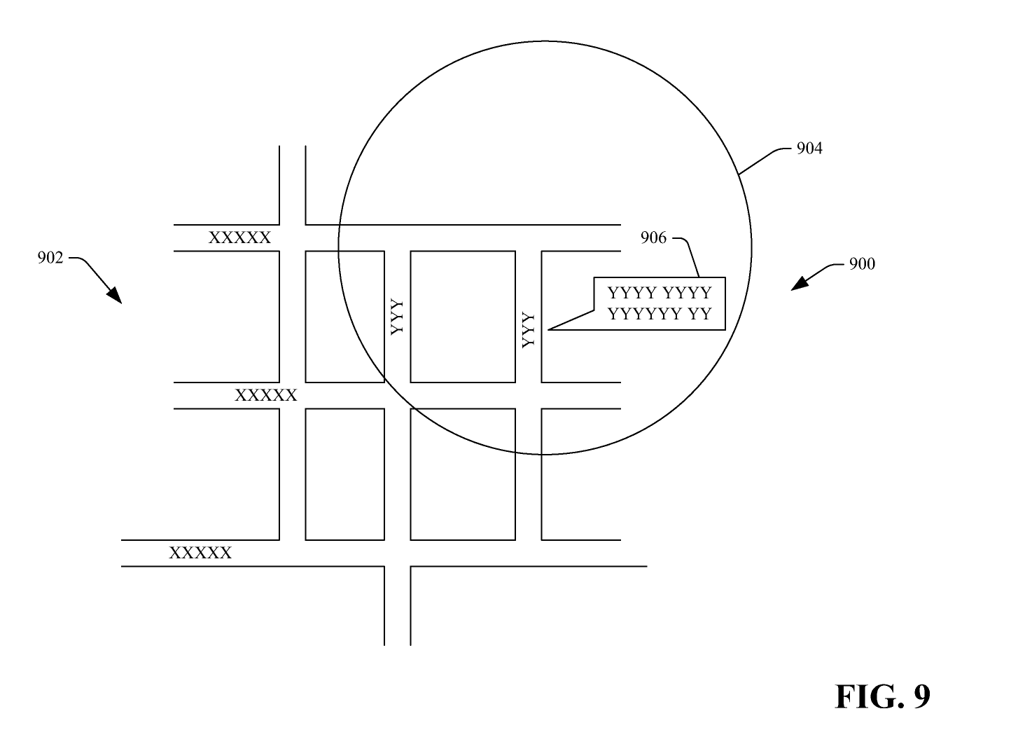

With reference now to FIG. 9, an example scenario 900 where an individual selects different portions of a map such that the portions of the map are displayed in a language understood by the individual is illustrated. A map 902 includes plurality of intersecting streets and text that describes such streets. Such map can be downloaded from the Internet, for example, and can be displayed on the interactive display of a surface computing device. Text of the map 902 describing streets, intersections, points of interest, etc. can be displayed in a first language that may not be understood by a viewer of such map 902. The viewer can select a portion of the map 902 by touching the map, by placing a tag on the interactive display at a certain location in the map, by placing a smart phone or other interactive device on the interactive display at a certain location on the map 902, etc. A zone 904 around such selection can be generated, wherein text within such zone 904 can be translated to a target language that is preferred by the individual. Size of the zone 904 can be controlled by the user (e.g., through a pinching gesture). Selection of such language has been described in detail above. Furthermore, any metadata corresponding to the map can be translated in the zone 904. For instance, the individual can select the street name and an annotation 906 can be presented to the individual, wherein such annotation 906 is displayed in the target language. Moreover, as indicated above, the individual can cause the zone 904 to move as the individual transitions a finger, smart phone, etc. around the map 902. If the aforementioned metadata includes a hyperlink that opens a web site (e.g., a web site of a business located at a position on the map that the user is touching), the web site can be automatically translated in the preferred language when opened. If, however, the web site already comprises versions for several languages including the preferred language of the user, this web site can be automatically opened instead of applying machine translation

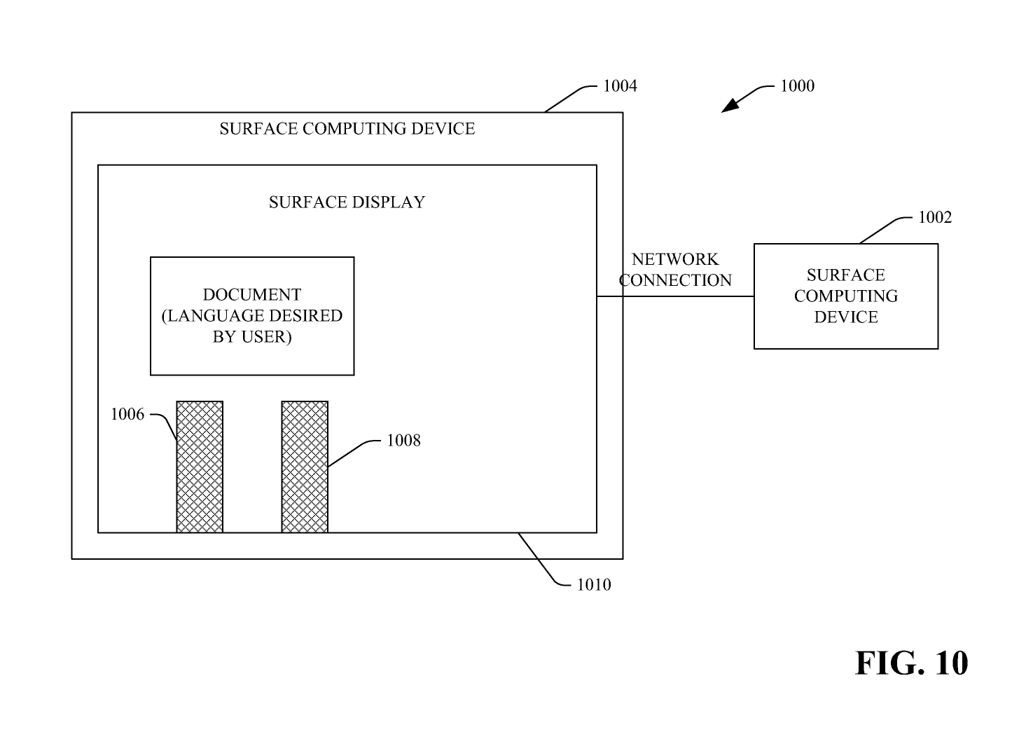

Now referring to FIG. 10, another example scenario 1000 is illustrated. In this example a first surface computing device 1002 is in communication with a second surface computing device 1004 by way of a network connection. Further, a user of the first surface computing device 1002 wishes to collaborate on a project with a user of the second surface computing device 1004. In an example, the user of the first surface computing device 1002 can have a document thereon that is being accessed by the first individual utilizing the first surface computing device 1002. Simultaneously, the user of the second surface computing device 1004 can see actions of the first individual on the first surface computing device 1002. Specifically, shadows 1006 and 1008 can be displayed on an interactive display 1010 of the second surface computing device 1004, wherein such shadows 1006 and 1008 indicate position and movement of arms and hands of the user of the first surface computing device 1002. Thus, the user of the second surface computing device 1004 can see how a document 1012 is being manipulated by the user of the first surface computing device 1002, wherein the document 1012 is in a language understood by the user of the second surface computing device 1004.

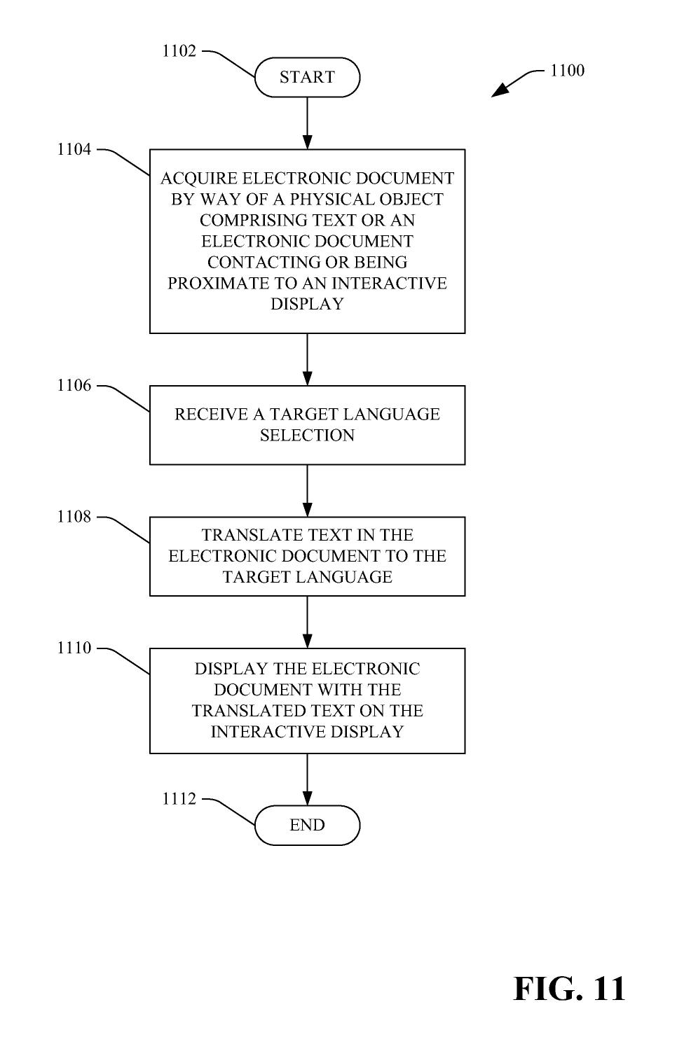

With reference now to FIGS. 11-13, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 11, a methodology 1100 that facilitates translating text in an electronic document on a surface computing device from a first language to a second language is illustrated. The methodology 1100 begins at 1102, and at 1104 an electronic document is acquired at a surface computing device by way of a physical object comprising text (such as a paper document) or a physical object comprising an electronic document (such as a smart phone) contacting or becoming sufficiently proximate to an interactive display of the surface computing device.

At 1106, a target language selection is received, wherein the target language is a language that is spoken/understood by a desired reviewer of the electronic document. At 1108, text in the electronic document is translated to the target language. For instance, the surface computing device can comprise a machine translation application that is configured to perform such translation. In another example, a web service can be called, wherein the web service is configured to perform such translation.

At 1110, the electronic document with the text translated to the target language is displayed to the user on the interactive display. The methodology 1100 completes at 1112.

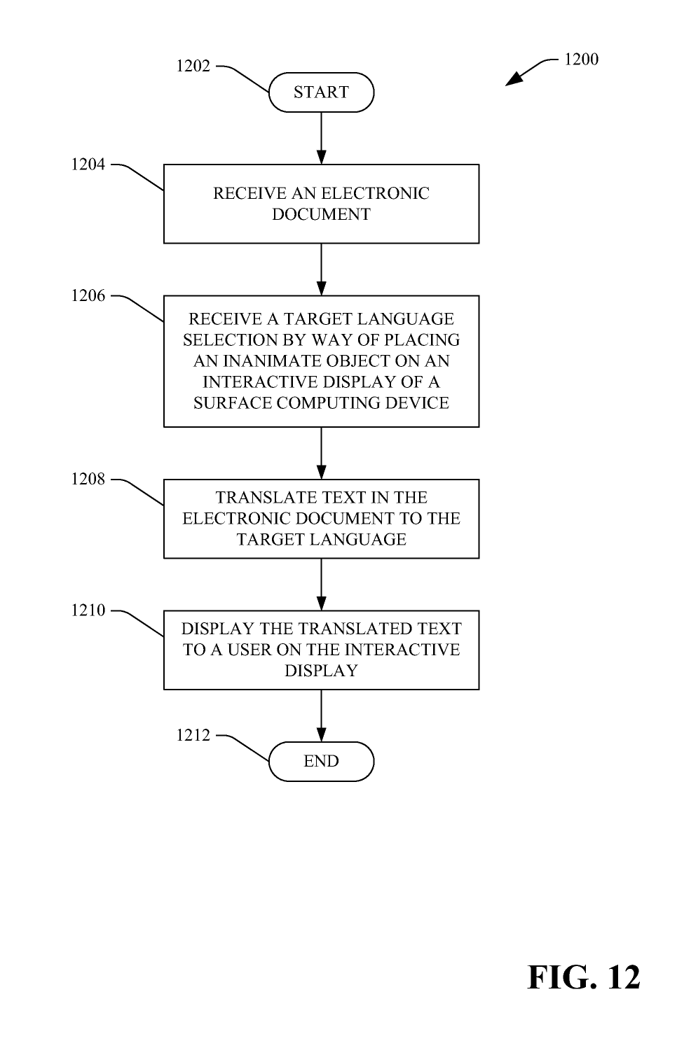

Referring now to FIG. 12, an example methodology 1200 that facilitates translating text in an electronic document from a first language to a second language on a surface computing device is illustrated. The methodology 1200 starts at 1202, and at 1204 an electronic document is received at the surface computing device. The electronic document can be generated anew by a user of the surface computing device, received from a disk, and/or received from some interaction with an interactive display of the surface computing device.

At 1206, a target language selection is received by way of detecting that an object has been placed on an interactive display of the surface computing device. The object can be a tag, a mobile computing device that can communicate with the surface computing device by way of a suitable communications protocol, etc.

At 1208, text in the electronic document is translated from a first language to the target language, and at 1210 the translated text is displayed to a user that speaks/understands the target language. The methodology 1200 completes at 1212.

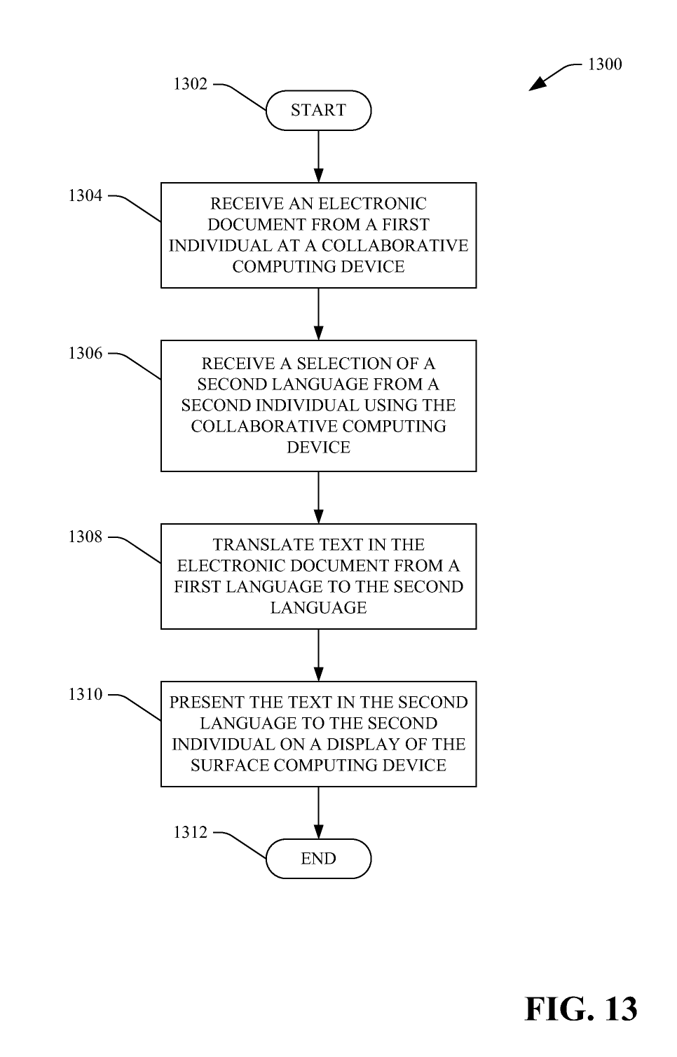

Referring now to FIG. 13, an example methodology 1300 that facilitates translating a document from a first language to a second language in a collaborative setting is illustrated. The methodology 1300 starts at 1302, and at 1304 an electronic document is received from a first individual at a collaborative computing device. For example, the collaborative computing device can be a surface computing device.

At 1306, a selection of a second language is received from a second individual using the collaborative computing device. At 1308, the text in the electronic document is translated from the first language to the second language, and at 1310 the text is presented to the second individual in the second language on a display of the collaborative computing device. The methodology 1300 completes at 1312.

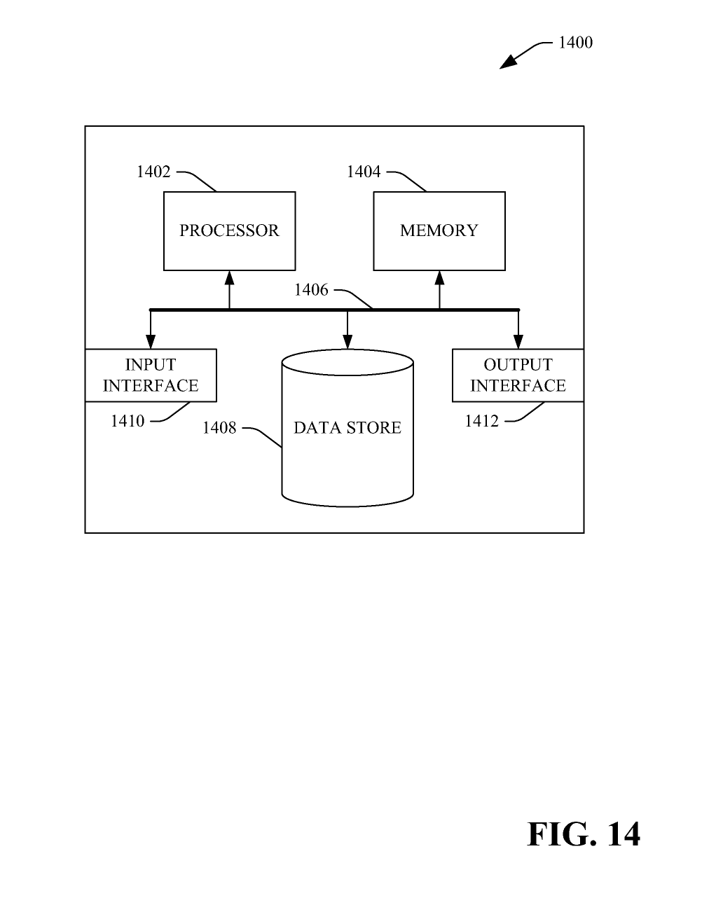

Now referring to FIG. 14, a high-level illustration of an example computing device 1400 that can be used in accordance with the systems and methodologies disclosed herein is illustrated. For instance, the computing device 1400 may be used in a system that supports collaborative computing. In another example, at least a portion of the computing device 1400 may be used in a system that supports translating text from a first language to a second language on a surface computing device. The computing device 1400 includes at least one processor 1402 that executes instructions that are stored in a memory 1404. The memory 1404 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store text, electronic documents, a database that correlates identities of individuals to language, etc.

The computing device 1400 additionally includes a data store 1408 that is accessible by the processor 1402 by way of the system bus 1406. The data store may be or include any suitable computer-readable storage, including a hard disk, memory, etc. The data store 1408 may include executable instructions, text, electronic documents, images, etc. The computing device 1400 also includes an input interface 1410 that allows external devices to communicate with the computing device 1400. For instance, the input interface 1410 may be used to receive instructions from an external computer device, from a user via an interactive display, etc. The computing device 1400 also includes an output interface 1412 that interfaces the computing device 1400 with one or more external devices. For example, the computing device 1400 may display text, images, etc. by way of the output interface 1412.

Additionally, while illustrated as a single system, it is to be understood that the computing device 1400 may be a distributed system. Thus, for instance, several devices may be in communication by way of a network connection and may collectively perform tasks described as being performed by the computing device 1400.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system comprising the following computer-executable components:
an acquirer component that acquires an electronic document that comprises text in a first language, wherein the acquirer component acquires the electronic document by way of an interactive display of a surface computing device, and wherein the acquirer component acquires the electronic document based at least in part upon a physical object comprising the text contacting or becoming proximate to the interactive display of the surface computing device;
a language selector component that receives an indication of a second language from a user of the surface computing device and selects the second language;
a translator component that translates the text in the electronic document from the first language to the second language; and
a formatter component that formats the electronic document for display to the user on the interactive display of the surface computing device, wherein the electronic document comprises the text in the second language.

2. The system of claim 1, wherein the physical object is a physical document, and wherein the acquirer component comprises a scan component that is configured to acquire the electronic document by capturing an image of the physical object by way of the interactive display.

3. The system of claim 1, wherein the physical object is a portable computing device, and wherein the acquirer component comprises a download component that is configured to download the electronic document from the portable computing device when the portable computing device is proximate to or in contact with the interactive display.

4. The system of claim 1, wherein the physical object is a physical document, wherein the electronic document is an image of the physical document, and wherein the acquirer component comprises an object character recognition component that recognizes the text in the image of the physical document.

5. The system of claim 1, wherein the language selector component receives the indication of the second language by way of interaction of the user with the interactive display.

6. The system of claim 5, wherein the language selector component receives the indication of the second language upon the user placing an object on or proximate to the interactive display.

7. The system of claim 6, wherein the object is a mobile computing device.

8. The system of claim 6, wherein the object is a tag.

9. The system of claim 1, wherein the language selector component receives the indication of the second language by analyzing a fingerprint of the user.

10. The system of claim 1, wherein the surface computing device is a collaborative computing device that is utilizable by a plurality of users at one time.

11. The system of claim 1, wherein the translator component is configured to translate the text from the first language to the second language when the electronic document is transitioned from a first zone of the interactive display to a second zone of the interactive display.

12. The system of claim 1, wherein the formatter component is configured to audibly output content of the electronic document in the first language or the second language.

13. A method comprising the following computer-executable acts:
receiving an electronic document at a surface computing device, wherein the electronic document comprises text in a first language;
receiving an indication from a first user that the text is desirably translated from the first language to a second language, wherein the indication is received by way of an object being placed upon or is proximate to an interactive display of the surface computing device;
translating the text from the first language to the second language subsequent to receipt of the indication; and
formatting the text in the second language for display to the first user.

14. The method of claim 13, wherein a second user provides the electronic document to the surface computing device, wherein the first user and the second user are collaborating on the surface computing device.

15. The method of claim 14, further comprising:
displaying a first instance of the electronic document to the first user on the interactive display, wherein the first instance of the electronic document comprises text in the second language; and
displaying a second instance of the electronic document to the second user on the interactive display, wherein the second instance of the electronic document comprises text in the first language.

16. The method of claim 15, further comprising
receiving selection of a portion of the text in the first instance of the electronic document from the first user; and
automatically highlighting a corresponding portion of the text in the second instance of the electronic document.

17. The method of claim 13, wherein the object is a portable computing device.

18. The method of claim 13, wherein the object is a tag.

19. The method of claim 13, wherein the electronic document is captured by way of interaction with the interactive display.

20. A computer-readable medium comprising instructions that, when executed by a processor, cause the processor to perform acts comprising:
receiving an electronic document from a first individual at a collaborative surface computing device, wherein the electronic document comprises text in a first language;
receiving a selection of a second language from a second individual at the collaborative surface computing device, wherein the second language is a preferred language of the second individual with whom the first individual is interacting via the collaborative surface computing device;
translating the text in the first language to text in the second language; and
presenting the text in the second language to the second individual on a display of the collaborative surface computing device.
